(19) United States
(12) Patent Application Publication
(10) Pub. No.: US 2017/0090565 A1
(43) Pub. Date: Mar. 30, 2017

(54) USER INTERFACES AND ASSOCIATED PROCESSES FOR INFORMATION RESOURCES

(71) Applicant: Sudheer A. Grandhi, Pleasanton, CA (US)

(72) Inventor: Sudheer A. Grandhi, Pleasanton, CA (US)

(21) Appl. No.: 15/373,861

(22) Filed: Dec. 9, 2016

Related U.S. Application Data
(62) Division of application No. 14/229,494, filed on Mar. 28, 2014.
(60) Provisional application No. 61/806,945, filed on Apr. 1, 2013.
(60) Provisional application No. 61/816,817, filed on Apr. 29, 2013.

(51) Int. Cl. G06F 3/01; G06F 3/0484; G06F 21/36; G06F 3/0488

(52) U.S. Cl. CPC G06F 3/013; G06F 3/04883; G06F 3/0484; G06F 21/36

(57) ABSTRACT

Methods and systems are disclosed for user interfaces and associated processes in computer applications and operating systems to provide an information resource area with information resources. In some embodiments, an information resource area is opened in response to detection of a user being idle for a predefined length of time with respect to an executing software program. In other embodiments an information resource area is opened in response to detection of a gesture by a user on the user interface displaying an executing software program. Various embodiments for rendering the information resource area and information resources are disclosed. Maintenance of the information resource area and the information resources may be based on user preferences. Embodiments for rendering the information resource area in conjunction with screen lock are also provided. In addition a multi-passcode security feature allowing device access at different levels of partial functionality is disclosed.

### FIELD OF INVENTION

The disclosed embodiments relate to user interfaces and associated processes in computer applications and operating systems to provide information resources.

### BACKGROUND

As computer based communication devices including portable devices proliferate computer applications supported in these devices continue to grow. Well known computer applications such as email, voice over internet protocol (VoIP), chat, social network, and gaming are commonly supported in many devices. More recently computer applications such as voice over long term evolution (VoLTE) and rich communication services (RCS) are being introduced especially on portable devices. As devices become more compact with smaller display screens design of user interfaces that allows efficient user interactions has become increasingly important. This is particularly so in portable communication devices such as mobile telephones, smartphones and tablet computers.

Conventional user interfaces in computer applications (e.g. email, VoIP, chat, social network, and gaming) and operating systems are not adequate to meet the challenges that arise in client devices with various capabilities. With the advent of client devices such as smartphones and computer tablets there are a plethora of computer applications and services that are of interest to a user on a client device. User interests are diverse and the priority of interests may not be the same for different users. Furthermore user interests may also change with time. User engagement and user experience, within an ecosystem of applications and services available on client devices, are very important in designing user interfaces in computer applications and operating systems. Serving advertisements that are relevant to user interests and associated priorities is another important consideration as well. Moreover these issues become more pronounced in portable communication devices with small display screens. Consequently there is a need for user interfaces and associated processes in computer applications and operating systems to efficiently address the issues highlighted above.

### SUMMARY

This summary is provided to serve as a simple introduction to the present invention that is further described in the detailed description. It is not the intention in this summary to capture all the essential features and elements of the invention. The present invention discloses embodiments for user interfaces and associated processes to provide information resources in computer applications and operating systems. Embodiments are disclosed to provide user interfaces in computer applications and operating systems which allow users to access, control and prioritize information resources of interest (e.g. third party resources, services and applications). Some disclosed embodiments provide user interfaces in computer applications and operating systems when it is detected that the user is idle or inactive over a predefined length of time. In some disclosed embodiments delivery of advertisements along with information resources is enabled. In some embodiments the advertisements may be based on user preferences such as prioritization of information resources of interest. The features and elements of the invention may be understood from reading the detailed description. The disclosed embodiments in the present invention for user interfaces and associated processes in computer applications and operating systems to provide information resources may be implemented on computer hardware and software platforms that may include one or more user interface systems and other peripheral units.

### BRIEF DESCRIPTION OF THE DRAWINGS

A better understanding of the embodiments of the present invention may be obtained from the detailed description below, given by way of example in conjunction with the following drawings.

FIG. 1 is a system diagram of an example networked system in which one or more disclosed embodiments may be implemented.

FIG. 2 is a block diagram of an example computer system in which one or more of the embodiments of the present invention may be implemented.

FIG. 3A illustrates an example user interface in an email application for a portable client device to provide an information resource area.

FIG. 3B illustrates an example user interface in an email application for a portable client device for rendering an information resource area.

FIG. 3C illustrates an example user interface in an operating system shell or computer application for a portable client device to provide an information resource area.

FIG. 3D illustrates an example user interface in an operating system shell or a computer application for a portable client device for rendering an information resource area.

FIG. 4A illustrates an example user interface in a webmail application within a web browser on a portable client device to provide an information resource area.

FIG. 4B illustrates an example user interface in a webmail application within a web browser on a portable client device for rendering an information resource area.

FIG. 5 is a flow chart of an example process for opening an information resource area in the user interface on detection of user inactivity in accordance with some embodiments.

FIG. 6 is a flow chart of an example process for changing user preferences in the information resource area in accordance with some embodiments.

FIG. 7 is a flow chart of an example process for providing advertisements by taking into account user preferences in the information resource area in accordance with some embodiments.

FIG. 8 is a flow chart of an example process for providing a multi-passcode security feature for a client device in accordance with some embodiments.

It will be appreciated that for simplicity and purposes of illustration elements in the figures are not necessarily drawn to scale. Furthermore, reference numbers may be repeated across figures to signify corresponding elements or features.

### DETAILED DESCRIPTION

A number of specific details are presented in the detailed description that follows to provide a thorough understanding of the present invention. However others skilled in the art will appreciate that the present invention may be practiced without these specific details. Details of well-known methods and systems have not been included in the description so as not to obscure the description of the embodiments of the present invention.

The terminology “information resource” as used in the description of the present invention includes anything or any item that has identity (e.g. resource name, resource identity, content identity, a uniform resource locator (URL), a uniform resource identifier (URI), uniform resource name (URN) or any combination thereof). Examples of an information resource include an electronic document, an image, a web page, a text file, a graphics file, an audio file, a video file, a multimedia file, a service (e.g. news report, weather report, stock market report, real estate information, notifications of events from computer applications), an advertisement, a computer application (e.g. telephony application, audio streaming application, video streaming application, multimedia streaming application, social network application, email application, text messaging application, map application, gaming application), an interface for access to a computer application. An information resource may also include a collection of other information resources.

The terminology of “information resource area” as used herein refers to any area on the user interface that displays or provides one or more information resources. For example an information resource area may be implemented as a window in a graphical user interface. In addition the terminology of “information resource sub-area” as used herein refers to any area which the display of an information resource fills or occupies within the information resource area. Each information resource is always associated with the corresponding information resource-sub-area which it fills or occupies when displayed. For example an information resource sub-area may be implemented as a window in a graphical user interface.

A user may interact with the operating system of a computer system through a graphical user interface for the operating system. The terminology “operating system shell” as used herein includes a process, software component or computer application that provides the graphical user interface for the operating system. The operating system shell may be implemented as a computer application that cooperates and communicates with the operating system to provide the graphical user interface for the operating system. The operating system shell may also be implemented as a process or software component of the operating system itself to provide the graphical user interface for the operating system. The graphical user interface for the operating system is referred to herein as the user interface of the operating system shell or the user interface of the operating system. A user interface of an operating system shell or operating system provides access to operating system services such as launching computer applications and computer file management. Note that a user interface of an operating system shell or operating system may also include in the display the user interfaces of one or more computer applications that are launched and running. In that sense the operating system shell even if implemented as a computer application is special and different from other computer applications.

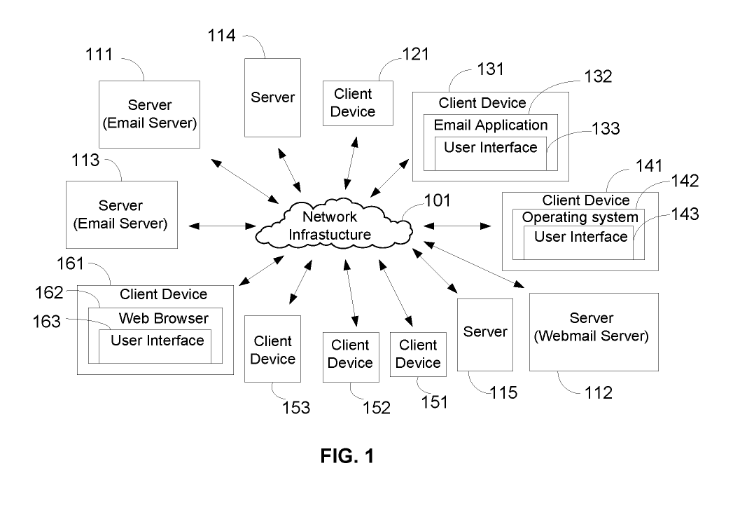

FIG. 1 is a system diagram of an example networked system in which the disclosed embodiments may be implemented. Disclosed embodiments for user interfaces and associated processes to provide information resources may be implemented in computer applications (e.g. email applications) or software components executed on a client device, a server or on servers and client devices communicating over a network infrastructure 101. Disclosed embodiments for user interfaces and associated processes to provide information resources may also be implemented in an operating system or operating system shell executed on a client device. The network infrastructure 101 may include wired and/or wireless networks. These networks may have security or may not have security. Client devices 121, 131, 141, 151, 152, 153, 161 may be mobile telephones, smartphones, television sets, tablet computers, computer laptops, computer desktops and the like which may be connected to the network infrastructure 101 on a wired or wireless communication link. Servers 111, 113 may be configured as email servers. A server 112 may be configured as a webmail server. Other servers 114, 115 may execute other computer applications besides email applications. Servers 114, 115 may provide information resources as well. The servers 114, 115 may be configured as advertisements servers to provide advertisements for display on client devices 121, 131, 141, 151, 152, 153, 161. In some scenarios an email application 132 providing a user interface 133 in accordance with the present invention may be implemented in an individual client device 131. An email application on a client device 131 is referred to sometimes as an email client application for which a server 111 may provide an email application referred to as an email server application. Client devices 121, 131, 141, 151, 152, 153, 161 may run their own email client applications and communicate over the network infrastructure 101. In other scenarios such as a webmail scenario an email application providing a user interface 163 in accordance with the present invention may be executed on a server 112 (configured as a webmail server) and accessed from a client device 161 for instance via a web browser 162. An email application executed on server 112 (configured as a webmail server) may be referred to as a webmail application. It will be appreciated that any computer application (e.g. email, VoIP, VoLTE, rich communication services, text messaging, social network, and gaming) providing a user interface in accordance with the present invention may be implemented in an individual client device. A computer application (e.g. email, VoIP, VoLTE, rich communication services, text messaging, social network, and gaming) on a client device is referred to sometimes as a client application for which a server may provide a corresponding application referred to as a server application. The scenarios considered herein may also include managed hosting or cloud hosting of a computer application (e.g. email application) where a computer application (e.g. an email application) is run on one or more servers and accessed from the client device via a web browser interface or a client application. In some scenarios an operating system shell 142 providing a user interface 143 in accordance with the present invention may be implemented in an individual client device 141. FIG. 1 is for illustration purpose only and well known technology components are not described in detail so as not to obscure the description of the embodiments. Furthermore many other configurations of devices, servers and nodes on the network infrastructure 101 may be used to implement computer applications (e.g. email, VoIP, VoLTE, rich communication services, text messaging, social network, and gaming), operating systems, or operating system shells providing user interfaces in accordance with the present invention.

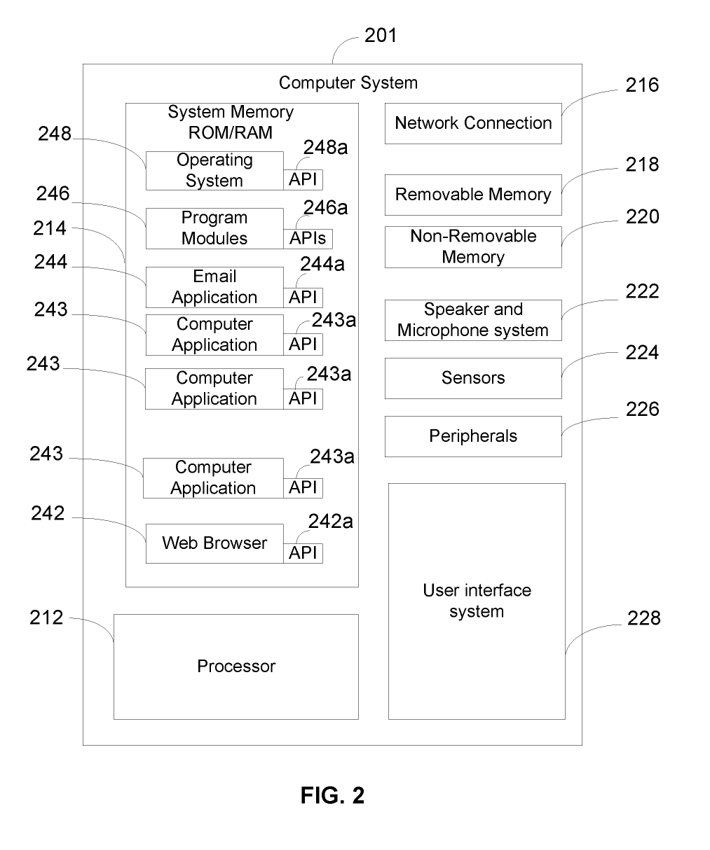

FIG. 2 is a block diagram of an example computer system 201 in which the embodiments of the present invention may be implemented. The computer system 201 may include a processor 212, a system memory 214, a network connection 216, a removable memory 218, a non-removable memory 220, a speaker and microphone system 222, sensors 224, peripherals 226 and a user interface system 228. The computer system 201 is provided just as an example without going into descriptive details of well-known technology components of computer systems capable of various functions. It will be appreciated by those skilled in the art that the computer system 201 may include any subset of the mentioned components or other components not mentioned. The computer system 201 in FIG. 2 may be a client device or a server depending on the component configuration.

The processor 212 may be any computer processor that is currently known or developed later. The system memory 214 may be non-volatile memory such as ROM, volatile memory such as RAM or a combination of non-volatile and volatile memory. An application programming interface (API) of an application allows communication with other computer applications and program modules. The system memory 214 includes an operating system 248, an email application 244, a web browser 242 and other program modules 246. The operating system 248 manages and controls various system tasks such as memory management and power management. The operating system 248 may also provide a graphical user interface to allow access to services provided by the operating system such as file management and execution of computer applications. The operating system 248 may include an API 248a. Program modules 246 in the system memory may be application software components such as a GPS module, a Camera module, a Telephone module and the like. Program modules 246 may include corresponding APIs 246a. The email application 244 enables email communication and provides a user interface in accordance with the present invention. Typically, the email application 244 may be used to create, send, receive and manage email messages. The email application 244 may include an API 244a. A plurality of computer applications collectively designated as 243 may also be present and any of them may provide a user interface in accordance with the present invention. For example a computer application may be any application such as email, VoIP, VoLTE, rich communication services (RCS), text messaging, social network, and gaming. A VoIP application provides telephony service based on internet protocols. A VoLTE application provides telephony service which has the advantage of radio protocol features of long term evolution (LTE) wireless technology in addition to being based on internet protocols. An RCS application may provide rich communication capabilities for voice/video calling (e.g. multimedia sharing during a call), messaging (e.g. group chat and file sharing) and phonebook (e.g. service discovery). A text messaging application allows electronic text message exchange between two or more users. A social network application provides a service that facilitates the building of social networks or social relations among users. A gaming application allows users to play games (e.g. video games) including games involving other users as players. A computer application 243 may include an API 243a. An operating system shell which provides a graphical user interface for the operating system 248 in accordance with the present invention may be implemented as a computer application 243 communicating with the operating system 248 (e.g. via API 243a and API 248a). The web browser 242 may typically be used to browse the world wide web, access web pages and receive content from servers. Furthermore the web browser 242 may enable a user to access an email application executed on a webmail server with the user interface of the email application provided to the user within the web browser.

The network connection 216 may be wired or wireless. As an example, the removable memory 218 may be a memory stick and the non-removable memory 220 may be a hard disk. The speaker and microphone system 222 is typically included in a computer system such as a smartphone or computer laptop and provides an audio interface. Sensors 224 may be proximity sensors or optical sensors which are typically included in a computer system such as a smartphone. Examples for peripherals 226 are digital cameras, universal serial bus (USB) port and the like.

The user interface system 228 enables interaction with the user for the user interface of a computer application (e.g. email, VoIP, VoLTE, rich communication services, chat, social network, and gaming) in accordance with the present invention. In addition, the user interface system 228 enables interaction with the user for the user interface of the operating system 248 in accordance with the present invention. The user interface system 228 supports a user interface comprising an input interface and an output interface between the computer system 201 (configured as a client device) and a user. The input interface detects or senses input from the user and the output interface renders or displays output to the user. The user interface system 228 may detect or sense any user input in any form including but not limited to voice, touch, gesture (e.g. hand, facial and body gesture), multi-touch, pressure, movement, motion, tilt, user gaze information, proximity, input with computer interface devices (e.g. computer mouse, touch pad, stylus) and the like. Furthermore the user interface system 228 may employ detection technologies currently known (such as touch sensitive screen, eye sensing and tracking, and “Air Gesture” as available on the latest smartphones) or developed later. The user interface system 228 may provide or render output to the user in any form including but not limited to visual, audio and haptic modes. For example visual output may include graphics currently known or developed later. The term graphics as used in the description of the present invention includes any visual element or characteristic that may be displayed to the user including but not limited to text, color, texture, intensity, shape, icons, images, animation and video. Furthermore the user interface system 228 may employ display or rendering technologies currently known (such as touch screen) or developed later.

A user input, action or gesture indicating proximity and/or interest in a displayed element or object on the user interface will be referred to in the description of the present invention as “hovering over” the displayed element or object. An example of such a user action is passing or moving a cursor over an icon with a computer mouse and this user action is referred to as “hovering over” the icon (which is different from selecting or activating the icon by clicking on it with a computer mouse). Another example of such a user action is bringing a finger close to a command or an icon on a touch screen interface (i.e. “hovering over” the screen) without actually touching the command or icon (e.g. “Air View” technology as available on the latest smartphones).

FIG. 2 is for illustration purpose only and well known technology components are not described in detail so as not to obscure the description of the embodiments. Furthermore many other configurations of computer components and peripherals may be used to implement processes providing user interfaces in computer applications (e.g. email, VoIP, VoLTE, rich communication services, text messaging, social network, and gaming), operating systems or operating system shells in accordance with the present invention.

An information resource area displays or provides one or more information resources. An information resource may be created or generated by communication (e.g. via APIs) with corresponding third party information resource entities such as one or more third party service providers, third party servers or third party computer applications. The information resources may be accessed and managed by the user within the information resource area by communication with the third party information resource entities. The communication may be over the network infrastructure to which all devices are connected. If the third party information resource is on the same client device then the communication is via APIs and shared memory on the device. Information resources may be accessed and managed by the user within the information resource area dynamically in real-time. Depending on the implementation an information resource may be created or generated for the information resource area at the client device, at one or more servers, or on the client device and one or more servers in a distributed manner. In addition, depending on the implementation the various information resources may be aggregated for the information resource area at the client device, at one or more servers, or on the client device and one or more servers in a distributed manner. In some cases user authentication may also be required to enable communication with a third party information resource entity. When the third party information resource entity is another computer application or application server the information resource may take the form of notifications of events from the computer application such as a missed call from a VoIP application, a new message from a text messaging application and a social network update from a social network application. Also the information resource may take the form for a minimized or essential part of a service or computer application. For example the information resource may be an interface to receive a weather report of a geographical area which is provided as input in the form of a postal code. In another example the information resource may take the form of an interface for photos, images and videos from a photo or camera application. In another example the information resource may take the form of an interface to another computer application such as an audio streaming application with essential controls like start and stop for streaming music. In another example the information resource may provide one or more control commands to invoke another computer application such as a telephony application and when the control command is activated the corresponding computer application is launched. In general examples for information resources include but are not limited to text messaging, video streaming, audio streaming, multimedia streaming, VoIP, webmail, email, social network, news reports, shopping network, stock price reports, weather reports and real estate information.

An information resource in the information resource area may be provided or implemented as an interface to a third party information resource entity (e.g. computer application on the client device, computer application on a server and service on a server). The interface and information contained in it may depend on the specific information resource and the corresponding third party information resource entity. The information in the interface could include location of the third party information resource entity, identifier of the resource, parameters for authentication, parameters and processes needed for accessing the resource and conducting a communication session, and any methods needed to parse or obtain specific information held within the third party information resource entity. Such interfaces may be implemented with any of the well-know technologies including but not limited to Simple Object Access Protocol for web service communications, JavaScript Object Notation, Representational State Transfer based services, Javascript, Rich Site Summary, Hypertext Transfer Protocol and Extensible Markup Language. Such interfaces may also be implemented with any technologies developed later for APIs and Web communication services and protocols. The well known technologies that may be used for providing or implementing information resources in the information resource area are not described in detail so as not to obscure the description of the embodiments.

In the description of the present invention a portable client device that includes a touch screen display is often used as an exemplary device in embodiments for the sake of simplicity. Sometimes a client device including a computer screen with user input from a computer mouse is used as an exemplary device in embodiments as well. However it should be understood and appreciated that the user interfaces and associated processes of the present invention may be applied to any other client device with one or more user interfaces.

In the description of the present invention email applications are used as exemplary computer applications in some embodiments for the sake of simplicity and clarity. However it should be understood and appreciated that the user interfaces and associated processes of the present invention may be applied to any computer application (e.g. email, VoIP, VoLTE, rich communication services, text messaging, social network, and gaming), operating system or operating system shell.

Email applications allow users to manage email messages with email commands. Email commands correspond to Create, Reply, Reply All, Forward, Send, Delete and other functions in managing email messages. For example a Reply command when activated by the user initiates creation of an email message replying to the sender of the selected email message. A Reply All command when selected or activated by the user initiates creation of an email message replying to the sender and all others included in the selected email message. A Create command when activated by the user initiates creation of a new email message. A Forward command when activated by the user initiates creation of an email to be forwarded. A send command when activated by the user sends the corresponding email message. A Delete command when activated by the user deletes the selected email. Email commands are rendered or displayed on the user interface by the email application in order to enable the user to activate them with user inputs or gestures (for example on a touch screen display the Reply command is rendered as an icon and may be activated by the user touching or tapping the Reply icon).

Depending on the implementation there may be more than one way of providing email message selection and associated user interfaces. In one way an email message listed in an email folder such as the Inbox when selected by the user using a pre-defined input or gesture results in a display of the full email message separate from the Inbox with email commands to manage it. In another way an email message listed in an email folder such as the Inbox when selected by the user using a pre-defined input or gesture results in a display of the email message within the Inbox with at least a subset of email commands to manage it. When a user selection of an email message is detected on the user interface in an email application typically commands such as Reply command, Reply All command, Forward command and Delete command may be displayed on the user interface to enable the user to manage the selected email. In some user interfaces the Reply command and Reply All command are grouped together possibly including one or more other email commands as a group of commands under a group command and this group of commands is displayed when the group command is activated. Email communication is most useful when the same message is to be sent to multiple recipients.

In one embodiment a process may open at least one information resource area separate from the display area of a computer application (e.g. email application, VoLTE application, RCS application) or operating system shell on detecting no input from the user in a user interface of the computer application or operating system shell over a predefined length of time. The process determines that the user is inactive or idle when no user input is detected in a user interface of the computer application or operating system shell over a predefined length of time. In some embodiments the predefined length of time may be set to different values for different user interfaces of the computer application (e.g. email application) or operating system shell. For example, in an email application the value set for the predefined length of time corresponding to the user interface for the Inbox Folder may be shorter than the value set for the predefined length of time corresponding to the user interface for creating/composing an email message. In the case of an RCS application for example, the predefined length of time for the user interface corresponding to a phonebook may be set differently than the predefined length of time for the user interface corresponding to messaging. When there is a change from one user interface to another in the computer application or operating system shell, the predefined length of time is updated by the process to the corresponding value for the current user interface of the computer application or operating system shell. In some embodiments the predefined length of time may be set according to a specific feature or parameter of a user interface of the computer application (e.g. email application) or operating system shell. An example of such a feature or parameter in an Inbox user interface of an email application is the time delay in refreshing the Inbox user interface to include the latest received email messages. In other embodiments user control settings for the computer application (e.g. email application), operating system shell or associated process may allow the user to set a value (e.g. within a specified range) for this predefined length of time. The user may also be allowed to set different values for this predefined length of time corresponding to different user interfaces of the computer application.

Eye sensing and tracking technologies use one or more sensors (e.g. optical, proximity, touch, acceleration) to obtain user gaze information (e.g. information relating to user looking at the user interface of the device, geometry of the user's eyes or face with respect to the user interface of the device, proximity of the user's eyes or face to the user interface of the device, angle of the user's eyes or face with respect to the user interface of the device, user gestures or expressions involving eyes or face, time duration of the user looking at the user interface). The terminology of “user gaze input detection” as used herein refers to detection of user interest with respect to the user interface determined based on the user gaze information obtained by eye sensing and tracking technologies (which includes face sensing and tracking as well) currently known or developed later. So if user gaze input is detected or received it corresponds to detection of user interest with respect to the user interface. On the other hand if user gaze input is not detected or received it corresponds to no detection of user interest with respect to the user interface. In computer applications or operating system shells that use eye sensing and tracking to detect user gaze input may include one or more of the following design methods in the process to determine whether the user is inactive or idle for the purpose of opening an information resource area. In some embodiments, if no user input including user gaze is detected from the user over a predefined length of time then it may be determined that the user is inactive or idle. In some embodiments, if only user gaze input is detected from the user with no other input from the user over a predefined length of time then it may be determined that the user is inactive or idle. The predefined length of time may be configurable in user control settings. The predefined length of time may be specific to a given user interface of a computer application or an operating system shell. In some embodiments, the process after determining that the user is inactive or idle based on detection of no user input including user gaze input from the user over a predefined length of time, may only open the information resource area based on detecting a user gaze input anew. In some embodiments a process may open the information resource area after a screen lock (a feature typically implemented on client devices such as smartphones) activation, on detecting no input from the user on the user interface of the client device over a predefined length of time. Typically a screen lock may be activated by the user with a predefined input or by the operating system based on predefined criteria for power savings.

In one embodiment a process may provide or display a prompt for a passcode input from the user when a user input is detected on the user interface (e.g. touch screen of a smartphone) after an information resource area was opened in response to detecting no input from the user over a predefined length of time in a user interface of the computer application (e.g. email application, VoLTE application, RCS application) or operating system shell. The term passcode as used herein refers to predetermined information or a security code provided by a user for gaining access to a protected resource. Examples of a passcode include but are not limited to a password, graphical password, security code and personal identification number. Note that in this embodiment even though the information resource area is being displayed on the user interface until detecting a user input on the user interface, the user is allowed access to the user interface only after providing the correct passcode as input in response to the prompt. This security feature may be enabled or disabled in the user control settings for the computer application, operating system shell or associated process. In some embodiments the same passcode may be accepted as that used for the screen lock feature typically implemented on client devices such as smartphones, tablet computers and laptop computers. In some embodiments instead of prompting for a passcode input the user interface may transition into a screen lock interface of the screen lock feature.

In some embodiments more than one passcode may be employed in a process providing a multi-passcode security feature for the client device. One passcode may allow access only to the information resource area. Another passcode may allow access not only to the information resource area but also to a subset of computer applications or a partial functionality of the device. Yet another passcode may allow access to all computer applications or full functionality of the device. This multi-passcode security feature may be implemented in the process to have different passcodes associated with allowing access to different levels of partial functionality of the device. For example a level of partial functionality may include access only to make or receive calls in a RCS/telephony application but may not allow access to phonebook or voicemail. In another example a level of partial functionality may include access only to gaming applications and not any other applications. In another example a level of partial functionality may include access only to gaming applications and utility applications (e.g. calculator, compass). In yet another example a level of partial functionality may include access only to a limited type of resources in the information resource area (e.g. advertisements, non-personal information resources or content). This multi-passcode security feature may be enabled or disabled in the user control settings for the computer application, operating system shell or associated process. The parameters associated with this multi-passcode security feature (e.g. passcodes, subsets of computer applications, levels of partial functionality of the device) may be set in the user control settings for the computer application, operating system shell or associated process. In some embodiments this multi-passcode security feature (i.e. different passcodes associated with allowing access to different levels of partial functionality of the client device) may be generally incorporated as an extension of the screen lock feature typically implemented on client devices. In some embodiments when the user has access only to a partial functionality of the client device after providing a corresponding passcode (in response to a prompt for a passcode) the user may at anytime lock the screen of the client device again (e.g. by pressing a corresponding preset button or by providing a predefined user input or gesture to activate the screen lock). This enables the user to unlock the screen again to obtain access to the full functionality or a partial functionality of the client device by providing the appropriate passcode. In some embodiments when the user has access only to a partial functionality of the client device, a command or icon may be provided in any user interface which when activated prompts the user to enter a passcode to obtain access to the full functionality of the device or a partial functionality of the device.

In one embodiment a process may open at least one information resource area separate from the display area of a computer application (e.g. email application, VoLTE application, RCS application) or operating system shell on detecting a predefined user input or gesture on any of the user interfaces of the computer application. For example the predefined user input may be an activation of a command or an icon, referred to herein as “Open command” or “Open icon”, which opens the information resource area. This Open command or Open icon may be activated by any predefined user input such as finger touch, tap or swipe. The Open command or Open icon for opening an information resource area may be displayed on any of the user interfaces of the computer application (e.g. email application) or operating system shell. In addition the Open command or Open icon may be displayed at any position on the user interface of the computer application (e.g. email application) or operating system shell. However for the convenience of the user the Open command or Open icon for opening an information resource area may be placed at a fixed location in all user interfaces (e.g. top, bottom, left, and right edge of a user interface assuming a rectangular user interface display) of a computer application (e.g. email application) or operating system shell. In an email application these user interfaces may be user interfaces for the Inbox Folder, any email Folder, processing a selected email message and creating/composing an email message. In an RCS application these user interfaces may correspond to phonebook, messaging, voice calling and video calling features. As another example the predefined user input or gesture may be a finger swipe to slide out the information resource area from an edge (e.g. top, bottom, left and right edge assuming a rectangular user interface display) of a user interface display of a computer application (e.g. email application) or operating system shell on the touch screen of a smartphone. Note that each of the examples for a predefined input or gesture to open an information resource area may be implemented alone or as a combination providing alternatives for the predefined input or gesture.

In one embodiment a process may close the information resource area on receiving a predefined input or gesture from a user on the information resource area or any of the user interfaces of the computer application (e.g. email application) or operating system shell. For example the predefined input or gesture may be a finger swipe to slide the information resource area away so that it disappears (e.g. into an edge of a rectangular user interface display). In another example the predefined input or gesture may be an activation of a command or an icon, referred to herein as “Close command” or “Close icon”, which closes the information resource area. This Close command or Close icon may be activated by any predefined user input such as finger touch, tap or swipe. The Close command or Close icon for closing the information resource area may be displayed at any position on the information resource area or the user interface of the computer application or operating system shell. However for the convenience of the user the Close command or Close icon may be placed at a fixed location on the information resource area (e.g. top, bottom, left, and right edge of the information resource area assuming it is of a rectangular shape) or the user interface of the computer application or operating system shell. Note that each of the examples for a predefined input or gesture to close an information resource area may be implemented alone or as a combination providing alternatives for the predefined input or gesture.

A process may render the information resource area for a computer application (e.g. email application, VoLTE application, RCS application) or operating system shell, as described in the following embodiments. In some embodiments the information resource area may be rendered (filling the user interface fully or partially) on top of the display area of the computer application (e.g. email application, VoLTE application, RCS application) or operating system shell and hence hiding or blocking the display area of the computer application or operating system shell below it from view. In some embodiments the information resource area may be rendered on the user interface (filling the user interface fully or partially) adjacent to the display area of the computer application (e.g. email application) or operating system shell. In some embodiments the information resource area may be rendered on the user interface (filling the user interface fully or partially) in such way that the display area of the computer application (e.g. email application) or operating system shell is accessible with a user input/gesture (e.g. by sliding it out with a finger swipe from the edge of the touch screen display on a smartphone or activating a command or an icon for accessing the display area of the computer application or operating system shell). In some embodiments any one of the above embodiments to render the information resource area may be used in any combination with the others. In some embodiments the information resource area may fill more than the user interface display (e.g. touch screen of a smartphone) where the user may scroll or navigate the information resource area with input or gestures to access information resource sub-areas that are not currently visible.

In one embodiment a process may render the information resource area for a computer application (e.g. email application, VoLTE application, RCS application) or operating system shell, as a collection of information resource sub-areas with each information resource sub-area displaying its corresponding information resource. For example the collection may be rendered in any form including but not limited to a list, circular list, rotating list, mosaic, tile, stack, layered stack or any combination thereof. In a trivial case the collection may be empty (i.e. no information resources in the information resource area) corresponding to a rendering of an empty or blank display of the information resource area. Each information resource sub-area may have a shape and boundary (e.g. a rectangular shape). The shape and boundary of an information resource sub-area is variable but constrained based on the specific information resource displayed in it. Each information resource sub-area within the information resource area may have an associated priority of display associated with it. For example the priority of display may correspond to any priority order including but not limited to a top to bottom priority order, a left to right priority order, a front to back priority order or any combination thereof.

In one embodiment a process may enable indication of user preferences in the information resource area for a computer application (e.g. email application, VoLTE application, RCS application) or operating system shell. The user preferences in the information resource area may be indicated with corresponding predefined user inputs or gestures. User preferences in the information resource area may relate to any controllable aspect of the configuration of the information resource area including but not limited to: (1) selection of an information resource to be displayed in a corresponding information resource sub-area (2) priority of display for an information resource or the corresponding information resource sub-area (3) time schedule for display of information resources (4) shape and boundary of an information resource sub-area corresponding to an information resource (5) shape and boundary of the information resource area. The indication of user preferences in the information resource area may be done dynamically while the user interacts with the resource information area. The indication of user preferences in the information resource area may also be done using controls provided in the user control settings for a computer application, an operating system shell or associated process.

The most recent configuration of an information resource area based on user preferences is stored, updated and maintained by the computer application, operating system shell or associated process as the case may be. A process rendering the information resource area may use the most recent configuration of the information resource area to render the information resource area. The process rendering the information resource area may also use the current user control settings for the information resource area to render the information resource area.

In some embodiments the priority of display of an information resource sub-area and the associated information resource may be changed by user input or gestures. For example a user may change the order of display of an information resource sub-area by dragging the information resource with a finger gesture to a desired position in the information resource area. In some embodiments a user may change the shape and boundary and the priority of display of an information resource sub-area with controls provided in the user control settings for the computer application, operating system shell or associated process.

A process may enable modifying user preferences in the information resource area for a computer application (e.g. email application, VoLTE application, RCS application) or operating system shell, as described in the following embodiments. In some embodiments the shape and boundary of an information resource sub-area may be changed by user input or gestures subject to the display constraints imposed by the specific information resource displayed within the information sub-area and the neighboring information resource sub-areas. For example a user may change the horizontal dimension or a vertical dimension of a rectangular shaped information resource sub-area by dragging its edges with a finger gesture on a touch screen display. When the limits of the display constraints imposed by the specific information resource displayed are attempted to be exceeded by user input no changes are made in the display of the corresponding information resource sub-area. In some embodiments the user may be able to schedule the display of an information resource using a time schedule including the priority of display for the information resource, in the user control settings for the computer application, operating system shell or associated process. In one example, the user may want to schedule the display of stock price reports (i.e. as an information resource) only during times when the stock market is open. In another example, the user may want to schedule the display of stock price reports at a lower priority of display when the stock market is closed than when the stock market is open. In some embodiments a process may allow the user to choose information resources to include in the information resource area by creating an information resource sub-area with predefined user input (e.g a command or gesture to open an information resource sub-area at a desired location and populate it with an information resource). The process may display a chosen information resource in the corresponding information resource-sub-area in the information resource area. In some embodiments a process may allow the user to change or modify information resources included in the information resource area. The process may allow the user to add or remove information resources and the corresponding information resource sub-areas in the information resource area with predefined inputs or gestures (e.g. activation of an icon to remove an information resource, dragging an information resource into the information resource area to add it). In some embodiments a user may add or remove information resources in the information resource area with controls provided in the user control settings of a computer application, an operating system shell or an associated process.

In one embodiment a process may render the information resource area for a computer application (e.g. email application, VoLTE application, RCS application) or operating system shell, as a circular or rotating list of information resource sub-areas where at any time at least one information resource sub-area is displayed in the visible portion of information resource area. A user may navigate to the other information resource sub-areas with a user input or gesture such as a finger swipe in the desired direction of rotation. In one embodiment when the user is determined to be idle or inactive (i.e. no user input or gesture is received on the user interface over a predefined length of time or duration) the rotation of the information resource sub-areas is carried out automatically by the associated process with a predefined time duration or length for the display of each information resource sub-area. The parameters for automatic rotation (e.g. predefined time length for the display of each information resource sub-area, predefined length of time over which user inactivity or user idle state is determined or detected) of the information resource sub-areas may be set by the user in the user control settings for the computer application, operating system shell or associated process. Any direction of rotation may be implemented for example a rotation in the vertical direction may be appropriate for an information resource area that opens up from a top or bottom edge of the user interface display.

In one embodiment a process may render the information resource in an enlarged display of the corresponding information resource sub-area when selected by the user. The enlarged display of the information resource sub-area may be closed by the user with a predefined input or gesture to return to the normal display of the information resource sub-area within the information resource area. If an information resource fills more than its display area the user may navigate the information resource sub-area using predefined user inputs to access those parts of the information resource that are currently hidden or not visible (e.g. finger swipes in the appropriate direction to scroll up or down).

A process may display advertisements in one or more information resource sub-areas in the information resource area for a computer application (e.g. email application, VoLTE application, RCS application) or operating system shell. In some embodiments the advertisements and the priority of display of the corresponding information resource sub-areas in which the advertisements are displayed, may take into account the user preferences in the information resource area. In some embodiments the advertisements displayed may be based on the user selection and prioritization of the information resources displayed in the information resource area. In some embodiments the priority of display of the advertisements (or the information resource sub-areas the advertisements are placed in) is based on the user preferences and prioritization of the information resources. In some embodiments the advertisements displayed may be based on time schedule information for display of information resources. In some embodiments the advertisements displayed may be based on size and shape information for rendering advertisements in information resource sub-areas. In some embodiments the advertisements displayed may be based on multimedia display capabilities for rendering advertisements in information resource sub-areas. In some embodiments the user may control one or more of: (1) number of information resource sub-areas allowed for advertisements in the information resource area (2) priority of display for an information resource sub-area corresponding to an advertisement (3) size and/or shape of an information resource sub-area corresponding to an advertisement. The advertisements may be dynamically changed to adapt to dynamic changes made to the information resource area by the user. In some embodiments the advertisements may be based on the information from the user calendar application associated with an email application. The computer application, operating system shell or an associated process may make available information relating to the configuration of the information resource area (e.g. user preferences in the information resource area, user preferences and prioritization of the information resources, information from an information resource, information from a computer application, time schedule based information for display of information resources, size and shape information for rendering advertisements in information resource sub-areas, multimedia display capabilities for rendering advertisements in information resource sub-areas) to an advertisement server which provides advertisements to be displayed based on the available information. For example the advertisement server may modify the presentation features and characteristics of an advertisement using the available information relating to size and shape for rendering advertisements. In another example the advertisement server may determine advertisement content or the advertisements itself using the available information relating to user preferences and prioritization of the information resources. In another example the advertisement server may modify the content of an advertisement or change the advertisement itself using the available information relating to time schedule for display of information resources. The computer application, operating system shell or an associated process and the advertisement server may cooperate and communicate over the network infrastructure in providing advertisements for display. It will be appreciated by those skilled in the art that any technology and configuration of advertisement servers currently known or developed later may be implemented on a network infrastructure to provide advertisements for display in the information resource area on a client device in accordance with the embodiments herein.

In one embodiment a predefined user input or gesture received for an information resource in the information resource area provided by a computer application (e.g. an email application) or operating system shell, may cause a process to open or launch a corresponding computer application or service. Subsequently, the computer application (e.g. email application) or operating system shell providing the information resource area may be maintained in the background (e.g. by multitasking computer applications on client devices such as smartphones). For example in an information resource corresponding to a telephony application a user input that activates a call command or icon may launch the telephony application. In a variation of this embodiment a prompt may be provided to the user to seek approval to proceed before opening the corresponding computer application. If the user does not approve then the user is returned to the user interface for the information resource area that was displayed prior to the reception of the predefined input or gesture from the user that generated the prompt.

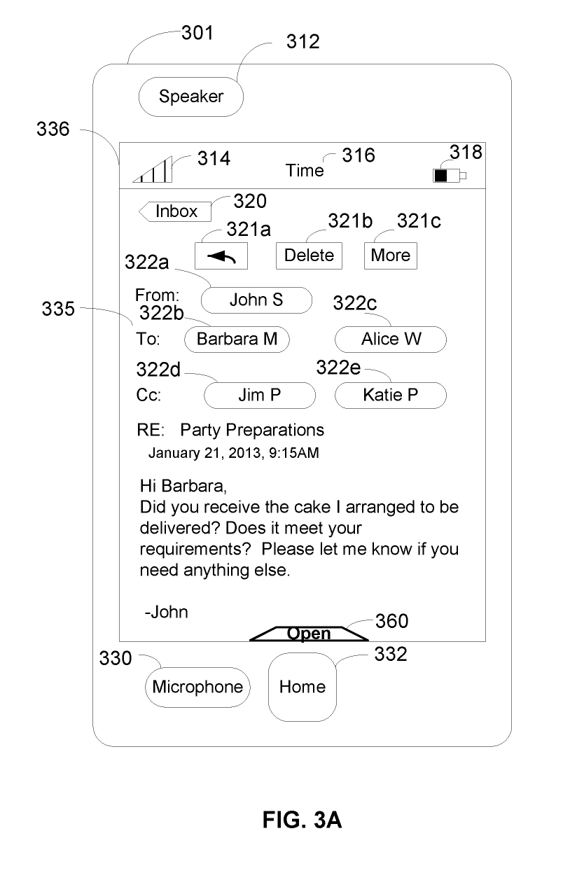

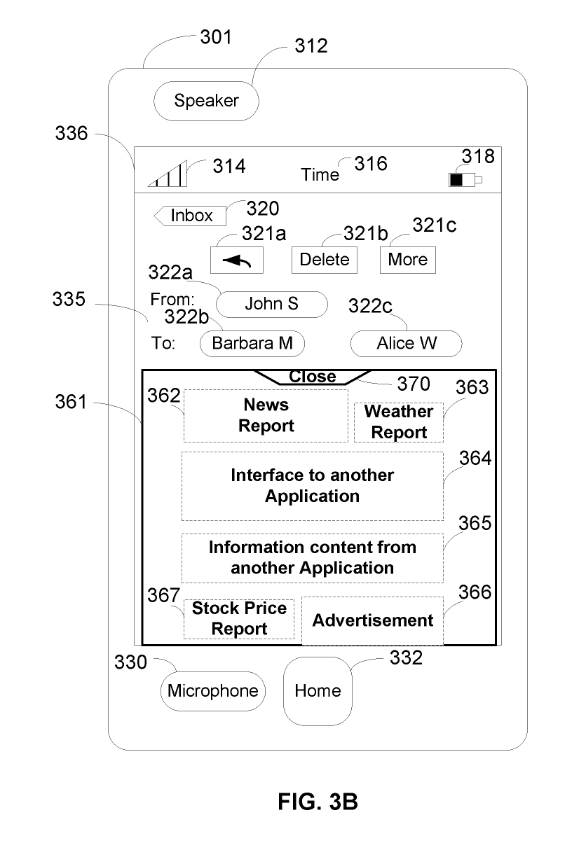

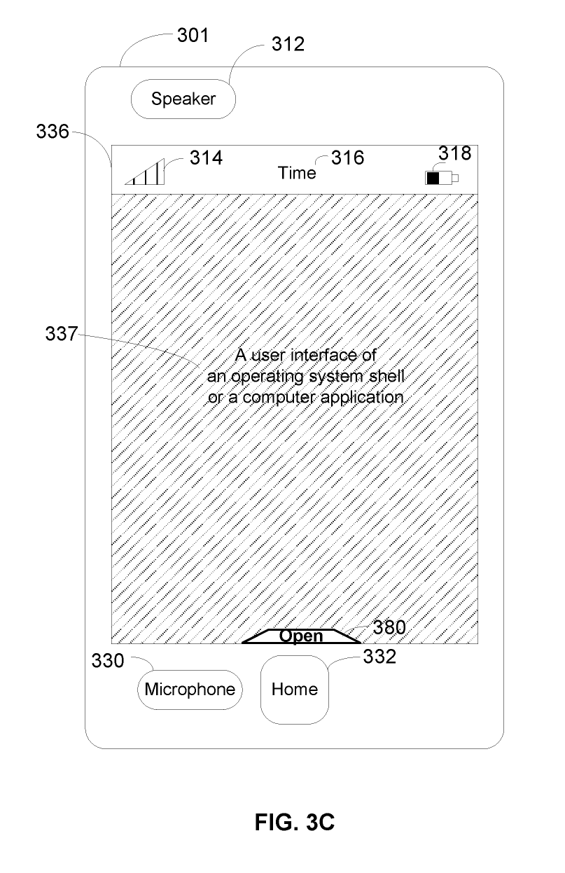

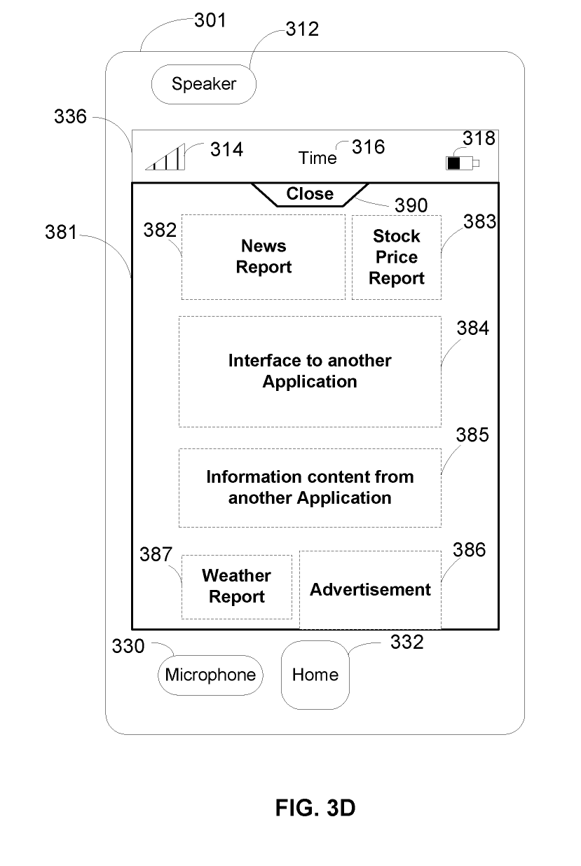

FIG. 3A is a diagram illustrating an example user interface in an email application for a portable client device 301 to provide an information resource area. The portable client device 301 includes a touch screen 336. The touch screen 336 is touch sensitive and displays various objects or commands which may be selected or activated by the user (e.g. by a finger tap on the icon for a command). The device 301 may include a speaker 312, a microphone 330 and a “Home” button 332 which may be used to navigate to the “Home” screen of the device to access and manage various applications that may be executed on the device. A signal strength indicator 314 for wireless network connection, the current time 316 and a battery level indicator 318 are included on the touch screen 336. It will be understood that FIG. 3A is for illustration purpose only and well known technology components of a portable communication device are not described in detail so as not to obscure the description of the embodiments. A user interface for the user selected email message 335 is displayed on the touch screen 336. The inbox icon 320 when activated initiates the display of the inbox of the email application. The Reply/Reply All/Forward icon 321a when activated initiates the display of the Reply, Reply All, and Forward commands or icons for the email message 335. The Delete icon 321b when activated initiates a user interface display that seeks confirmation to delete the email message 335. The More icon 321c when activated provides more commands or functions to manage the email message 335. The user selected email message 335 as displayed includes the name 322a of the sender, names 322b, 322c of the recipients in the To address list, names 322d, 322e of the recipients in the Cc address list, the subject line, the date, the time and the body or content of the email message 335. An Open icon 360 may be rendered on the user interface for the email application in accordance with embodiments of the present invention which when activated opens an information resource area. Even though the Open icon 360 is shown at the bottom edge of the user interface for the email application in FIG. 3A, it will be appreciated that it may be rendered at any position on the user interface for the email application. For example the Open icon may be rendered at the top edge of the user interface of the email application and when activated may open an information resource area from that top edge (i.e. the information resource area may be dropped down or extended downward from that top edge). It will be understood that the Open icon 360 is depicted as shown in FIG. 3A for illustration purpose only and may be implemented with any graphics known currently or developed later. It will be appreciated that one or more elements of the user interface described in FIG. 3A for providing an information resource area are also applicable to the webmail scenario where the user interface for an email application executed on a webmail server may be accessed and displayed within a web browser on the touch screen 336.

FIG. 3B is a diagram illustrating an example user interface in an email application for a portable client device 301 for rendering an information resource area 361. The opening and display of information resource area 361 may be a result of any corresponding process in accordance with embodiments of the present invention. For example information resource area 361 may have been opened based on a user input or gesture such as a finger swipe which slides out the information resource area from an edge of the user interface, activation of an Open command such Open icon 360 in FIG. 3A, or detecting no input from the user in a user interface of the email application over a predefined length of time. The touch screen 336, speaker 312, microphone 330, “Home” button 332, signal strength indicator 314, current time 316 and battery level indicator 318 are the same as described in FIG. 3A. The user interface for the user selected email message 335 is displayed on the touch screen 336 partially covered by the information resource area 361. Inbox icon 320, Reply/Reply All/Forward icon 321a, Delete icon 321b, More icon 321c, name 322a of the sender, and names 322b, 322c of the recipients in the To address list are the same as described in FIG. 3A. The information resource area 361 includes information resource sub-areas for a news report 362, a weather report 363, an interface to another computer application 364, information content from another computer application 365, a stock price report 367, and an advertisement 366. A Close icon 370 is also included which when activated will close the information resource area 361. Even though the Close icon 370 is shown at the top edge of the information resource area 361, it will be appreciated that it may be rendered at any position on the information resource area 361 or the user interface for the email application. It will be understood that the Close icon 370 is depicted as shown in FIG. 3B for illustration purpose only and may be implemented with any graphics known currently or developed later. It will be appreciated that the information resource area 361 may be closed without using or implementing the Close icon 370. For example the information resource area 361 may be closed on receiving a predefined input or gesture from a user on the information resource area such as a finger swipe to slide the information resource area away so that it disappears (e.g. into an edge of the email user interface). It will be appreciated that one or more elements of the user interface described in FIG. 3B for rendering an information resource area are also applicable to the webmail scenario where the user interface for an email application executed on a webmail server may be accessed and displayed within a web browser on the touch screen 336.

FIG. 3C is a diagram illustrating an example user interface in an operating system shell or computer application for a portable client device 301 to provide an information resource area. The touch screen 336, speaker 312, microphone 330, “Home” button 332, signal strength indicator 314, current time 316 and battery level indicator 318 are the same as described in FIG. 3A. A user interface 337 of an operating system shell or a computer application is displayed on the touch screen 336 and shown or depicted in FIG. 3C as the area filled with a pattern of parallel lines. For example a user interface of an operating system shell or operating system may be the “Home” screen of a client device displaying computer application icons which may be activated to execute or launch the corresponding computer applications on the client device. An Open icon 380 may be rendered on the user interface of the operating system shell or computer application in accordance with embodiments of the present invention which when activated opens an information resource area. Even though the Open icon 380 is shown at the bottom edge of the user interface of the operating system shell or computer application in FIG. 3C, it will be appreciated that it may be rendered at any position on the user interface of the operating system shell or computer application. For example the Open icon may be rendered at the top edge of the user interface of the operating system shell or computer application and when activated may open an information resource area from that top edge (i.e. the information resource area may be dropped down or extended downward from that top edge). It will be understood that the Open icon 380 is depicted as shown in FIG. 3C for illustration purpose only and may be implemented with any graphics known currently or developed later. It will be appreciated that one or more elements of the user interface described in FIG. 3C for providing an information resource area are also applicable to a web based computer application scenario where the user interface for a web based computer application executed on a server may be accessed and displayed within a web browser on the touch screen 336.

FIG. 3D is a diagram illustrating an example user interface in an operating system shell or a computer application for a portable client device 301 for rendering an information resource area 381. The opening and display of information resource area 381 may be a result of any corresponding process in accordance with embodiments of the present invention. For example information resource area 381 may have been opened based on a user input or gesture such as a finger swipe which slides out the information resource area from an edge of the user interface, activation of an Open command such Open icon 380 in FIG. 3C, or detecting no input from the user in a user interface of the operating system shell or computer application over a predefined length of time. The information resource area 381 as shown in FIG. 3D covers the entire user interface display of the operating system shell or computer application (e.g. user interface display of the operating system shell or computer application 337 in FIG. 3C). The touch screen 336, speaker 312, microphone 330, “Home” button 332, signal strength indicator 314, current time 316 and battery level indicator 318 are the same as described in FIG. 3A. The information resource area 381 includes information resource sub-areas for a news report 382, a stock price report 383, an interface to another computer application 384, information content from another computer application 385, a weather report 387, and an advertisement 386. A Close icon 390 is also included which when activated will close the information resource area 381. Even though the Close icon 390 is shown at the top edge of the information resource area 381, it will be appreciated that it may be rendered at any position on the information resource area 381 or the user interface of the operating system shell or computer application. It will be understood that the Close icon 390 is depicted as shown in FIG. 3D for illustration purpose only and may be implemented with any graphics known currently or developed later. It will be appreciated that the information resource area 381 may be closed without using or implementing the Close icon 390. For example the information resource area 381 may be closed on receiving a predefined input or gesture from a user on the information resource area such as a finger swipe to slide the information resource area away so that it disappears (e.g. into an edge of the user interface of the operating system shell or computer application). It will be appreciated that one or more elements of the user interface described in FIG. 3D for rendering an information resource area are also applicable to a web based computer application scenario where the user interface for a web based computer application executed on a server may be accessed and displayed within a web browser on the touch screen 336.

It will be understood that FIG. 3B, FIG. 3C and FIG. 3D are for illustration purpose only and well known technology components of a portable communication device are not described in detail so as not to obscure the description of the embodiments.

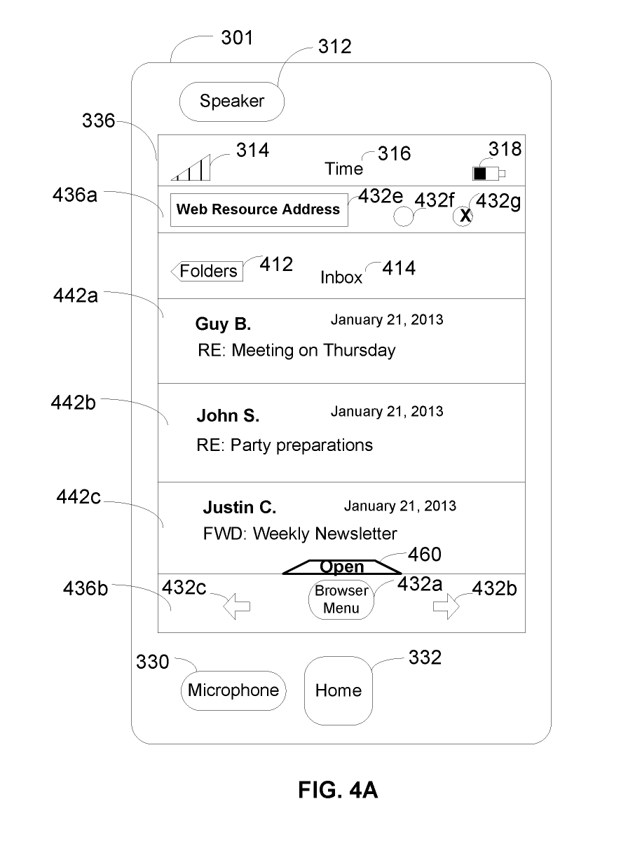

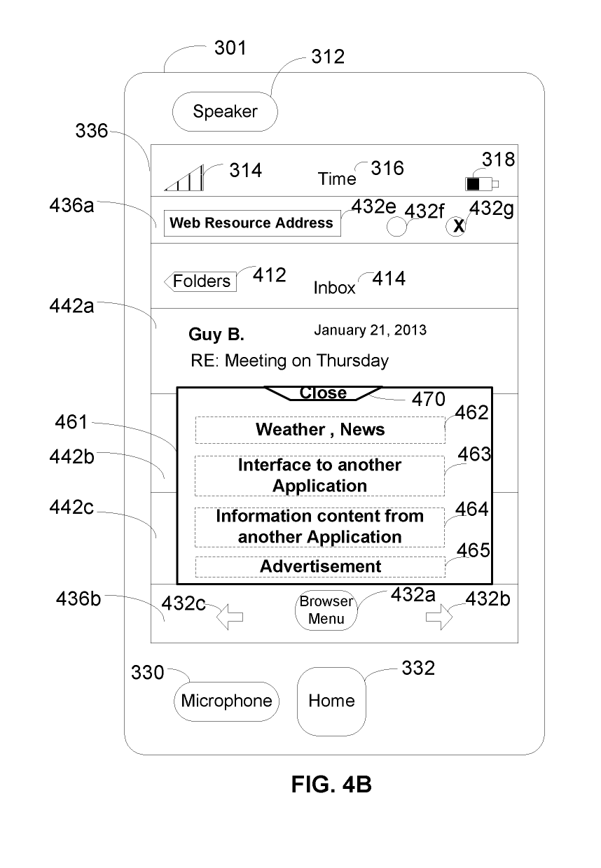

FIG. 4A is a diagram illustrating an example user interface in a webmail application within a web browser on a portable client device 301, to provide an information resource area. The touch screen 336, speaker 312, microphone 330, “Home” button 332, signal strength indicator 314, current time 316 and battery level indicator 318 are the same as described in FIG. 3A. It will be understood that FIG. 4A is for illustration purpose only and well known technology components of a portable communication device are not described in detail so as not to obscure the description of the embodiments. A web browser enables users to access and view web information resources on the world wide web such as web pages, documents, images, video files, multimedia files and content provided by servers. A web information resource is referred to here as a web resource for convenience. A user interface for the Inbox 414 of a webmail application is displayed within a web browser with a top web browser panel 436a and a bottom web browser panel 436b. The top web browser panel 436a includes a web resource address bar 432e, a refresh icon 432f and a stop icon 432g. To access or load a web resource and view it in the web browser the corresponding web resource address is entered by the user in the web resource address bar 432e. The refresh icon 432f when activated reloads the web resource and the stop icon 432g when activated stops the loading of the web resource. The bottom web browser panel 436b includes a Browser menu icon 432a which when activated provides a user interface with a menu of commands to manage the web browser and web pages. The bottom web browser panel 436b also includes a Forward icon 432b and a Back icon 432c to go forward and back, respectively, in navigating web resources. The Folders icon 412 when activated initiates the display of the folders used to manage the email messages in the email application. Email messages 442a, 442b, 442c are displayed with the sender name, subject line and date in the user interface for the Inbox 414. An Open icon 460 may be rendered on the user interface for the email application in accordance with embodiments of the present invention which when activated opens an information resource area. Even though the Open icon 460 is shown at the bottom edge of the user interface for the email application in FIG. 4A, it will be appreciated that it may be rendered at any position on the user interface for the email application. For example the Open icon may be rendered at the top edge of the user interface of the email application and when activated may open an information resource area from that top edge (i.e. the information resource area may be dropped down or extended downward from that top edge). It will be understood that the Open icon 460 is depicted as shown in FIG. 4A for illustration purpose only and may be implemented with any graphics known currently or developed later. It will be appreciated that one or more elements of the user interface described in FIG. 4A for providing an information resource area are also applicable to the email application scenario where an email application (i.e. an email client application) is executed on a portable client device 301 with the touch screen 336.

FIG. 4B is a diagram illustrating an example user interface in a webmail application within a web browser on a portable client device 301, for rendering an information resource area 461. The opening and display of information resource area 461 may be a result of any corresponding process in accordance with embodiments of the present invention. For example information resource area 461 may have been opened based on a user input or gesture such as a finger swipe which slides out the information resource area from an edge of the user interface, activation of an Open command such Open icon 460 in FIG. 4A, or detecting no input from the user in a user interface of the email application over a predefined length of time. The touch screen 336, speaker 312, microphone 330, “Home” button 332, signal strength indicator 314, current time 316 and battery level indicator 318 are the same as described in FIG. 3A. A user interface for the Inbox 414 of a webmail application is displayed within a web browser with a top web browser panel 436a and a bottom web browser panel 436b. Web resource address bar 432e, refresh icon 432f, stop icon 432g, Browser menu icon 432a, Forward icon 432b and Back icon 432c are the same as described in FIG. 4A. The user interface for the Inbox 414 of the webmail application is partially covered by the information resource area 461. In the user interface for the Inbox 414 of the webmail application, email messages 442a, 442b, 442c and Folders icon 412 are the same as described in FIG. 4A. Note that email messages 442a, 442b, 442c are partially covered by the information resource area 461. The information resource area 461 includes information resource sub-areas for a weather and news report 462, an interface to another computer application 463, information content from another computer application 464 and an advertisement 465. A Close icon 470 is also included which when activated will close the information resource area 461. Even though the Close icon 470 is shown at the top edge of the information resource area 461, it will be appreciated that it may be rendered at any position on the information resource area 461 or the user interface for the email application. It will be understood that the Close icon 470 is depicted as shown in FIG. 4B for illustration purpose only and may be implemented with any graphics known currently or developed later. It will be appreciated that the information resource area 461 may be closed without using or implementing the Close icon 470. For example the information resource area 461 may be closed on receiving a predefined input or gesture from a user on the information resource area such as a finger swipe to slide the information resource area away so that it disappears (e.g. into an edge of the email user interface). It will be appreciated that one or more elements of the user interface described in FIG. 4B for rendering an information resource area are also applicable to the email application scenario where an email application (i.e. an email client application) is executed on a portable client device 301 with the touch screen 336.

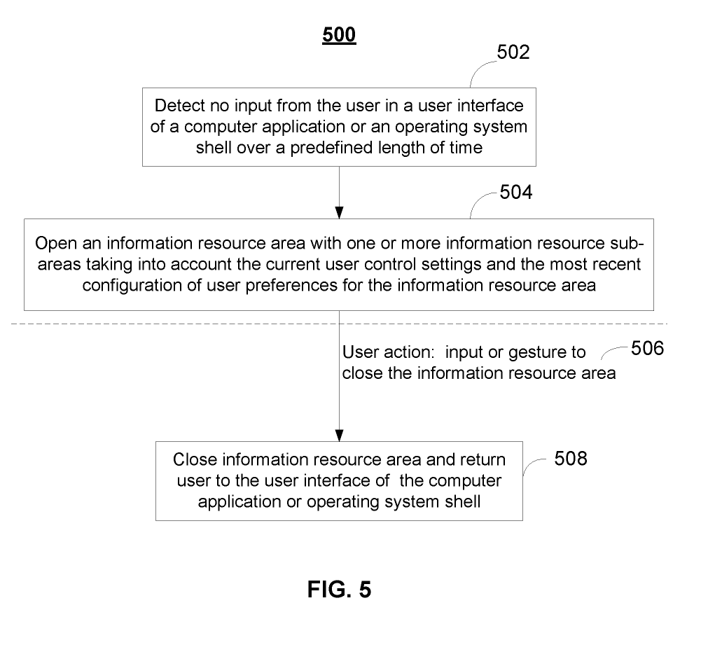

FIG. 5 is a flow chart of an example process 500 for opening an information resource area in the user interface on detection of user inactivity in accordance with some embodiments. The process 500 starts with detection of no input from the user in a user interface of a computer application or an operating system shell over a predefined length of time. (502). An information resource area is opened with one or more information resource sub-areas taking into account the current user control settings and the most recent configuration of user preferences (which is stored, updated and maintained by the computer application, operating system shell or associated process as the case may be) for the information resource area (504). In response to a user action (506) to close the information resource area, the information resource area is closed and the user is returned to the user interface of the computer application or operating system shell (508). The process 500 is provided for illustration purposes. It will be appreciated that embodiments for providing information resources in the user interface on detection of user of inactivity may be implemented by similar processes using the principles described herein.

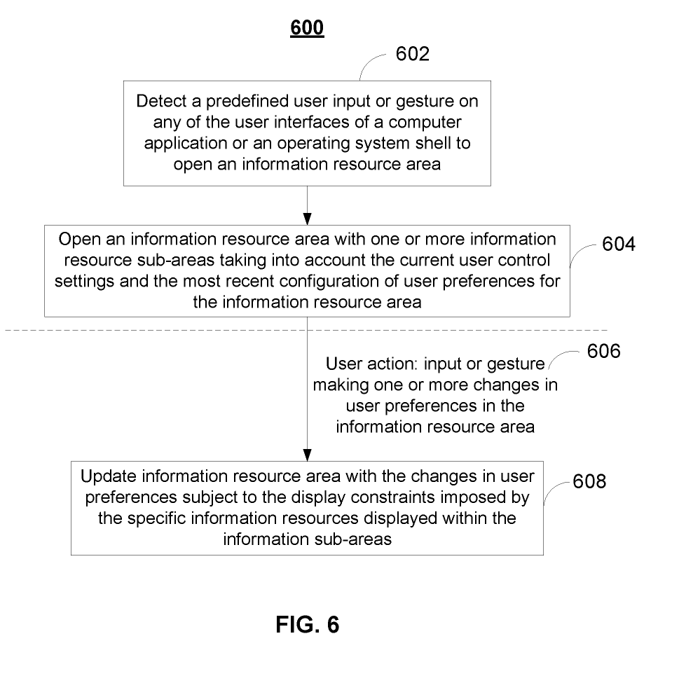

FIG. 6 is a flow chart of an example process 600 for changing user preferences in the information resource area in accordance with some embodiments. A predefined user input or gesture is detected on any of the user interfaces of a computer application or an operating system shell for opening an information resource area (602). An information resource area is opened with one or more information resource sub-areas taking into account the current user control settings and the most recent configuration of user preferences (which is stored, updated and maintained by the computer application, operating system shell or associated process as the case may be) for the information resource area (604). In response to a user action (606) that is an input or gesture which makes one or more changes in user preferences in the information resource area, the information resource area is updated with the changes in user preferences subject to the display constraints imposed by the specific information resources displayed within the information sub-areas (608). The process 600 is provided for illustration purposes. It will be appreciated that embodiments for changing user preferences in the information resource area may be implemented by similar processes using the principles described herein.

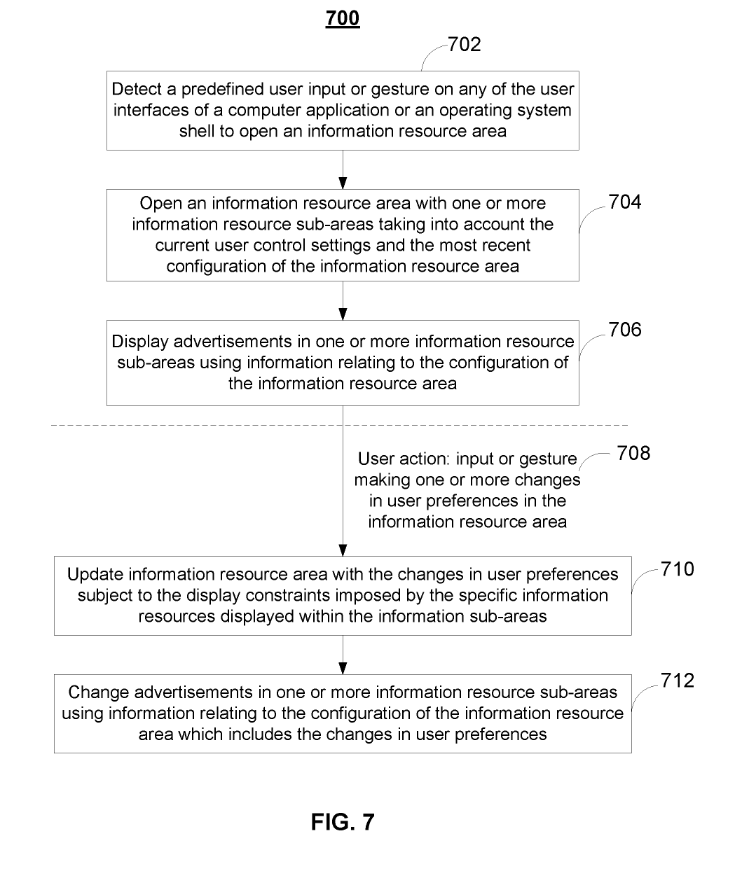

FIG. 7 is a flow chart of an example process 700 for providing advertisements by taking into account user preferences in the information resource area in accordance with some embodiments. A predefined user input or gesture is detected on any of the user interfaces of a computer application or an operating system shell for opening an information resource area (702). An information resource area is opened with one or more information resource sub-areas taking into account the current user control settings and the most recent configuration of the information resource area (which is stored, updated and maintained by the computer application, operating system shell or associated process as the case may be) (704). Advertisements are displayed in one or more information resource sub-areas using information relating to the configuration of the information resource area (706). In response to a user action (708) that is an input or gesture which makes one or more changes in user preferences in the information resource area, the information resource area is updated with the changes in user preferences subject to the display constraints imposed by the specific information resources displayed within the information sub-areas (710). The advertisements in one or more information resource sub-areas are changed using information relating to the configuration of the information resource area which includes the changes in user preferences (712). The process 700 is provided for illustration purposes. It will be appreciated that embodiments for providing advertisements by taking into account user preferences in the information resource area may be implemented by similar processes using the principles described herein.

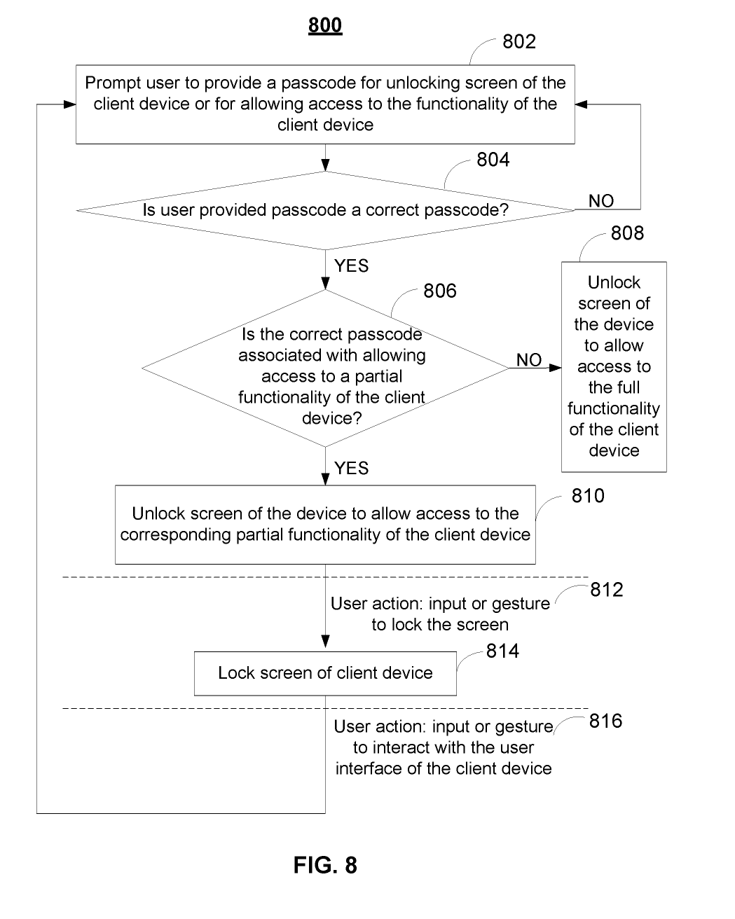

FIG. 8 is a flow chart of an example process 800 for providing a multi-passcode security feature for a client device in accordance with some embodiments. The process 800 starts with prompting the user to provide a passcode, for unlocking the screen of the client device or for allowing access to the functionality of the client device (802). If the user provided passcode (804) does not correspond to a correct passcode, the user is prompted again to provide a passcode, for unlocking the screen of the client device or for allowing access to the functionality of the client device (802). If the user provided passcode (804) corresponds to a correct passcode and if the correct password is associated with allowing access to a partial functionality of the client device (806), the screen of the device is unlocked to allow access to the corresponding partial functionality of the client device (810). If the user provided passcode (804) corresponds to a correct passcode and if the correct password is not associated with allowing access to a partial functionality of the client device (806), the screen of the device is unlocked to allow access to the full functionality of the client device (808) (i.e. the correct password in this case is associated with allowing access to the full functionality of the client device). In response to a user action (812) corresponding to an input or gesture to lock the screen, the screen of the client device is locked (814). In response to a user action (816) corresponding to an input or gesture to interact with the user interface of the client device, the user is prompted to provide a passcode, for unlocking the screen of the client device or for allowing access to the functionality of the client device (802). The process 800 is provided for illustration purposes. It will be appreciated that embodiments for providing a multi-passcode security feature for a client device may be implemented by similar processes using the principles described herein.

In one embodiment controls or settings for disabling (“turning off”) one or more features or elements described above may be included in the user interface of the user control settings for the computer application (e.g. email application, VoLTE application, RCS application) or operating system shell, to allow the user to disable (“turn off”) one or more features or elements. User controls for enabling (“turning on”) disabled features or elements may also be included in the user interface of the user control settings for the computer application or operating system shell. For example, a setting or control may be provided in the user control settings (in the corresponding user interface) to disable or enable display of advertisements in the information resource area. As another example, a setting or control may be provided in the user control settings (in the corresponding user interface) to disable or enable opening of the information resource area in the user interface on detection of user of inactivity. User control settings for disabling or enabling may be defined for each feature or element separately or in any combination with the other features and elements. Furthermore configuration parameters for one or more features or elements described above may be included in the user interface for user control settings of the computer application or operating system shell. For example a setting or control may be provided in the user control settings to predefine a length of time for detecting user inactivity to open the information resource area in a user interface of a computer application (e.g. email application, RCS application) or operating system shell. In one embodiment the user control settings for the computer application may be included in a user interface provided by the computer application. In an alternative embodiment the user control settings for the computer application may be included in a user interface outside of the computer application (for example in the user interface provided for the general user control settings for the client device as a whole by the operating system or operating system shell of the client device).

Embodiments disclosed in the present invention may be implemented as one or more processes in the computer application or operating system shell on the client device to produce the user interfaces in accordance with the present invention.

Embodiments disclosed in the present invention may be implemented as one or more processes in computer applications on the client device and one or more servers to produce the user interfaces in accordance with the present invention.

Embodiments disclosed in the present invention may be implemented as one or more processes in the computer application on one or more servers to produce the user interfaces in accordance with the present invention.

Embodiments disclosed in the present invention may be implemented as one or more value added processes (e.g. add-on software, plug-in software) on the client device to cooperate with the computer application or operating system shell in producing the user interfaces in accordance with the present invention. In another embodiment these value added processes may be remotely installed over the network on to the client device.

Embodiments disclosed in the present invention may be implemented as one or more value added processes (e.g. add-on software, plug-in software) on the client device to cooperate with the web browser in producing the user interfaces in computer applications (e.g. email applications, RCS applications) in accordance with the present invention. In this scenario the user accesses a computer application executed by one or more servers via a web browser interface. In another embodiment these value added processes may be remotely installed over the network on to the client device.

It will be understood and appreciated that embodiments disclosed in the present invention, even if described using a portable client device may be practiced in any client device including but not limited to a Smartphone, Computer Tablet, Personal computer and Television set.

Even if features and elements are described or depicted above in specific combinations, others skilled in the art will understand and appreciate that each feature or element may be used individually or in any combination with the other features and elements.

Although the present invention has been described using specific embodiments disclosed herein, others skilled in the art will appreciate that modifications may be made to the embodiments without departing from the scope of the invention.

What is claimed is:

1. A method for rendering an information resource area, executed at least in part in a computer system with a user interface system supporting a touch screen display, the method comprising:
receiving an indication of a detection of a user of the computer system being idle for a predefined length of time with respect to at least one computer software program executing in the computer system; and
at least partly in response to receiving the indication, opening on the touch screen display supported by the user interface system the information resource area including at least one information resource.

2. The method of claim 1, wherein the at least one computer software program is a computer application.

3. The method of claim 1, wherein the at least one computer software program is an operating system shell.

4. The method of claim 1, wherein the at least one computer software program is a screen lock application.

5. The method of claim 1, wherein the detection of a user being idle for a predefined length of time comprises detecting no input from the user on the user interface of the at least one computer software program.

6. The method of claim 1, wherein the detection of a user being idle for a predefined length of time comprises determining user interest based on user gaze information, wherein the user interface system is capable of obtaining user gaze information.

7. The method of claim 1, further comprising rendering a current user interface, wherein the predefined length of time is determined based at least in part on the current user interface.

8. The method of claim 1, wherein at least part of content for the at least one information resource included in the information resource area is received through a network connection supported by the computer system.

9. The method of claim 1, wherein the at least one information resource is an interface to a computer application.

10. The method of claim 1, wherein the at least one information resource is an advertisement.

11. The method of claim 1, further comprising maintaining the information resource area based at least in part on user preferences in the information resource area.

12. The method of claim 1, further comprising opening the information resource area from an edge of the touch screen display supported by the user interface system.

13. The method of claim 1, further comprising:
detecting a second gesture from the user with respect to the at least one information resource;
prompting for a passcode input from the user to allow access to the at least one information resource; and
in response to receiving a correct passcode input from the user, allowing access to the at least one information resource.

14. The method of claim 1, further comprising detection of a user of the computer system being idle for a predefined length of time with respect to the at least one computer software program executing in the computer system.

15. A computer system comprising:
one or more processors;
a user interface system supporting a touch screen display;
memory accessible to the one or more processors; and
one or more programs stored in the memory which when executed by the one or more processors causes the computer system to perform a method for rendering an information resource area comprising:
receiving an indication of a detection of a user of the computer system being idle for a predefined length of time with respect to at least one computer software program executing in the computer system; and
at least partly in response to receiving the indication, opening on the touch screen display supported by the user interface system the information resource area including at least one information resource.

16. One or more programs for rendering an information resource area including a non-transitory computer readable storage medium storing the one or more programs configured to be executed by a computer system with a user interface system supporting a touch screen display, the one or more programs including instructions for:
receiving an indication of a detection of a user of the computer system being idle for a predefined length of time with respect to at least one computer software program executing in the computer system; and
at least partly in response to receiving the indication, opening on the touch screen display supported by the user interface system the information resource area including at least one information resource.
